(19) United States
(12) Patent Application Publication
(10) Pub. No.: US 2018/0351884 A1
(43) Pub. Date: Dec. 6, 2018

(54) System and Method for Individualizing Messages

(71) Applicant: Taneshia Pawelczak, Middle Village, NY (US)

(72) Inventor: Taneshia Pawelczak, Middle Village, NY (US)

(21) Appl. No.: 15/992,761

(22) Filed: May 30, 2018

Related U.S. Application Data
(60) Provisional application No. 62/512,274, filed on May 30, 2017.

(51) Int. Cl. H04L 12/58; H04W 4/12; G10L 13/08; H04M 3/533

(52) U.S. Cl. CPC H04L 51/02; H04W 4/12; H04M 3/53391; H04L 51/38; G10L 13/08

(57) ABSTRACT

A system and method for individualizing messages. The system includes a mobile device in wireless communication with a telecommunications network, wherein the mobile device includes a memory having a logic thereon. The logic initiates the method, wherein the method includes creating a subset of callers from a set of possible callers, assigning an identifier to the subset of callers, creating a conditional response associated with the identifier, and executing the conditional response. The conditional responses include playing a voicemail message associated with the identifier when a caller from the subset of callers associated with the identifier is directed to leave a voicemail, adding a signature associated with the identifier to a text message from the caller, or replying to the text message with a pre-determined message when a text message is received during a designated special status period.

### CROSS REFERENCE TO RELATED APPLICATIONS

This application claims the benefit of U.S. Provisional Application No. 62/512,274 filed on May 30, 2017. The above identified patent application is herein incorporated by reference in its entirety to provide continuity of disclosure.

### BACKGROUND OF THE INVENTION

The present invention relates to a system and method for individualizing messages. Specifically, it relates to a system and method for creating subsets of callers such that each subset of callers receives a different voicemail or text message response.

Many people set up voicemail systems to greet callers and request that a message be left, however current phone systems only allow a user to associate a single outgoing voicemail message per account. This results in every caller hearing the same outgoing voicemail message, no matter the relationship the caller has with the phone owner. This presents an issue for users who receive both casual and professional calls on a single phone, as the outgoing voicemail message can be either too formal or too casual for the particular caller. Traditionally, a user is forced to resort to a formal outgoing voicemail message, even in the case where formal callers are rare. Therefore, a need exists for a system that allows a user to assign a particular outgoing voicemail message to a subset of incoming callers, such that casual acquaintances and friends are greeted with a sufficiently casual voicemail message, and formal or business associates are greeted with a sufficiently formal voicemail message.

In light of the devices disclosed in the known art, it is submitted that the present invention substantially diverges in design elements from the known art and consequently it is clear that there is a need in the art for an improvement to existing systems and methods for individualizing messages. In this regard, the instant invention substantially fulfills these needs.

### SUMMARY OF THE INVENTION

In view of the foregoing disadvantages inherent in the known types of systems and methods for individualizing messages now present in the known art, the present invention provides a system and method for individualizing messages wherein the same can be utilized for providing convenience for the user when playing a desired voicemail message for a specific individual caller or group of callers.

The present system comprises a mobile device in wireless communication with a telecommunications network, wherein the mobile device includes a user interface and a non-transitory computer readable memory having a logic thereon. The logic is configured to create a subset of callers from a set of possible callers, assign an identifier to the subset of callers, and create conditional responses associated with the identifier. The conditional responses include playing a voicemail message associated with the identifier when a caller from the subset of callers associated with the identifier is directed to leave a voicemail, adding a signature associated with the identifier when a text message is sent to a caller from the subset of callers associated with the identifier, and replying to a text message with a pre-written message when a text message is received during a designated special status period. In some embodiments, the voicemail message comprises an audio message pre-recorded to the non-transitory computer readable memory. In another embodiment, the voicemail message comprises a text message converted to audio via a text-to-speech algorithm. In other embodiments, the set of possible callers comprises a contact list stored on the non-transitory computer readable memory. In yet another embodiment, the logic is configured to require a passcode be entered on the user interface before allowing a user to create subsets of callers.

The present method comprises accessing a set of possible callers located on a non-transitory computer readable memory of a mobile device in wireless communication with a telecommunications network, creating a subset of callers from the set of possible callers, assigning an identifier to the subset of callers, recording a voicemail message for each of the subsets of callers to the non-transitory computer readable memory, assigning each voicemail message to one of the identifiers, and playing the voicemail message associated with the identifier when a caller from the subset of callers is directed to leave a voicemail. In some embodiments, the method further comprises recording a signature for each of the subsets of callers to the non-transitory computer readable memory and adding the signature associated with the identifier to a text message sent to a caller from the subset of callers associated with the identifier. In another embodiment, the method further comprises recording a special status message to the non-transitory computer readable memory, setting the mobile device to a special status period, and replying to a text message with the special status message when the mobile device is set to the special status period. In other embodiments, the method further comprises storing a passcode to the non-transitory computer readable memory and prompting the user to enter the passcode before the set of possible callers is accessed. In yet another embodiment, the voicemail message comprises an audio message. In some embodiments, the voicemail message comprises a text message converted to an audio message by a text-to-speech algorithm. In another embodiment, the special status message is recorded for each identifier, such that the special status message is sent in response to a text message from a caller associated with the identifier.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a flowchart of an embodiment of the method for individualizing messages.

### DETAILED DESCRIPTION OF THE INVENTION

Reference is made herein to the attached drawings. Like reference numerals are used throughout the drawings to depict like or similar elements of the system and method for individualizing messages. For the purposes of presenting a brief and concise description, callers shall be discussed as a person dialing a phone number to initiate either a phone call or text message. Additionally, a subset of callers as described below can include any number of callers, including a single individual. The figures are intended for representative purposes only and should not be considered to be limiting in any respect.

The system for individualizing messages comprises a mobile device in wireless communication with a telecommunications network, such that the mobile device is capable of making and receiving calls. A non-transitory computer readable memory is disposed on the mobile device, the non-transitory computer readable memory having a logic thereon, the logic configured to execute a method. The logic can comprise programming inherent to the mobile device, or alternatively, an application that can be installed by the user to execute the method. The method allows a user to separate multiple known contacts or phone numbers into distinct groupings, each grouping assigned a particular identifier, such that when a call or text is received by a contact with a grouping, a response is generated based on the assigned identifier associated with the grouping. The groupings of callers can include any number of callers, such that the user can create large groups, or associate responses to a single individual. The mobile device further comprises a user interface configured to allow the user to input commands into the mobile device to be executed by the logic disposed on the non-transitory computer readable memory. In some embodiments, the logic requires that the user register a passcode upon initial activation, such that upon subsequent activations, the user is required to enter the passcode via the user interface before the user is permitted to create or manage new subsets of users, as well as creating or managing responses associated with each identifier. In this way, the user is ensured that the desired responses associated with each identifier are not interfered with by a third-party, such that security is maintained.

The method executed by the logic comprises creating a subset of callers from a list of possible callers, assigning an identifier to the subset of callers, and creating and executing a conditional response for each identifier. Specifically, in one exemplary use, the subset of callers comprises a list of known contacts or phone numbers sharing a common trait or relationship, such as friend groups, family members, business contacts, co-workers, and the like. The list of possible callers can comprise an existing contact list located on the mobile device, the existing contact list accessed by the logic, such that each separate subset of callers can be easily created and managed by the user. Once each subset of callers is created, an identifier is associated with the subset of callers. The identifier serves to differentiate each subset of callers, such that the correct conditional response associated with the subset of callers is sent. Finally, the user can input a desired conditional response for each subset of callers, such that the conditional response can be executed once the conditions are met.

In one exemplary embodiment, the conditional response can include playing an outgoing voicemail message to a caller when the caller is directed to leave a voicemail. Once the incoming call is received, the logic determines the subset of callers that the caller is a member of, and plays the outgoing voicemail message associated with the subset of callers via the identifier. In this way, the user can associate various outgoing voicemail messages appropriate for each subset of callers, such that professional associates receive a sufficiently formal outgoing voicemail message while friendly associates can receive a casual outgoing voicemail message. Furthermore, as each subset of callers is created by the user, the user can create detailed and personalized outgoing voicemail messages for each of the subsets of callers. In some embodiments, a default outgoing voicemail message can be created, such that when a caller not located in any existing subset of callers is directed to leave a voicemail, an appropriately general outgoing voicemail message is played. In some embodiments, the outgoing voicemail message can comprise an audio file recorded by the user, while in alternate embodiments, the outgoing voicemail message can comprise a text file converted to synthetic speech via a text-to-speech algorithm. In this way, the user can further personalize the outgoing voicemail message, should the user feel that a synthesized voicemail message is more appropriate for a desired subset of callers.

Alternatively, the conditional response can include appending a signature associated with the identifier to a text message sent to a caller in the subset of callers. A user can create various signatures associated with each subset of callers, such that, if desired, any text message sent to a caller automatically includes the desired signature. In this way, when the user sends a text message to a caller, the logic identifies the correct subset of callers that the caller belongs to, and automatically enters the signature associated with the subset of callers to the text message. In some embodiments, the signature can further be automatically added to the text of an email sent to a caller, should the caller's email address be included in the contact list used to generate each subset of callers. In this way, the user can attach a desired signature to each text communication sent to a caller from each subset of callers, wherein the signature is tailored to the recipient.

The logic is further configured to allow a user to set the mobile device to recognize a special status period. Special status periods indicate periods of time during which responding to a text message or phone call could be dangerous, unsafe, or otherwise difficult, such as while driving, on an airplane, or in a meeting or other situation that a user cannot immediately respond. During these special status periods, a special status message is automatically generated when a call or text message is received, wherein the special status message is associated with the appropriate subset of callers as indicated by the identity of the caller. In this way, when a user is otherwise occupied and cannot immediately respond, the special status message is sent to the caller. This allows a user to indicate that the reasoning for not immediately returning a text message is not intentional and is only a product of the current circumstances. In some embodiments, the user can selectively identify a plurality of potential special status periods, wherein a special status message is associated with each of the plurality of special status periods. This allows the user to particularly indicate the circumstances preventing the user from responding immediately.

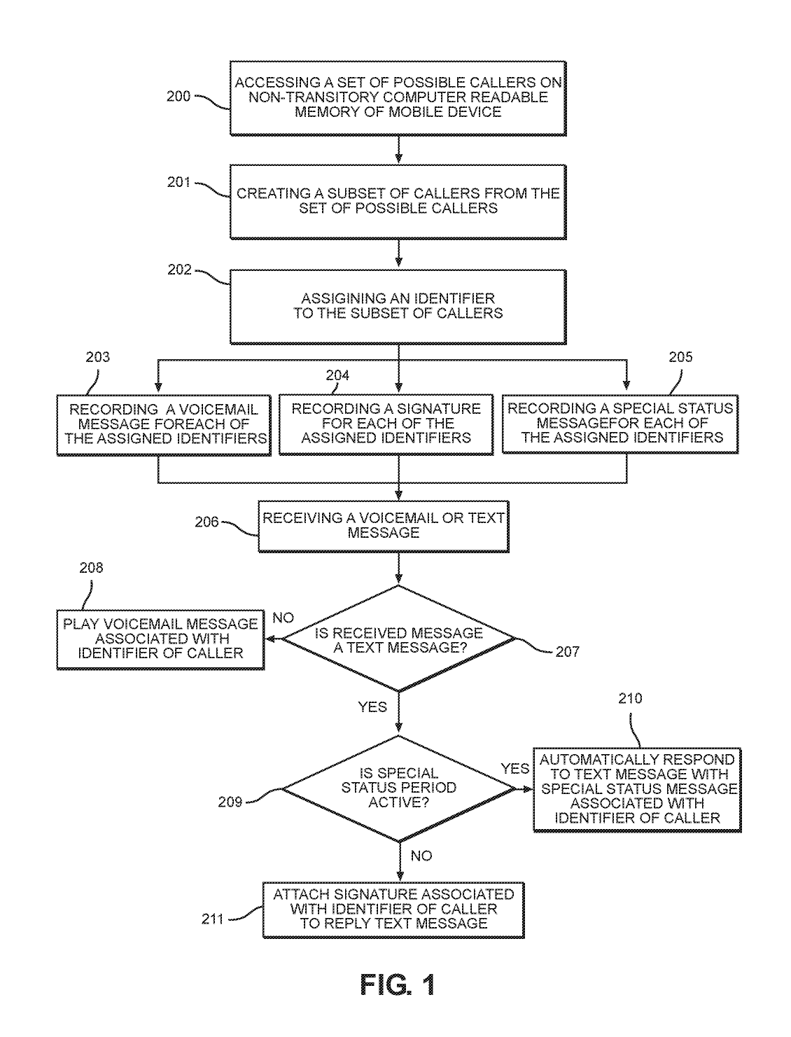

Referring now to FIG. 1, there is shown a flowchart of an embodiment of the method for individualizing messages. In the illustrated embodiment, the method comprises accessing a set of possible callers 200 located on the non-transitory computer readable memory of the mobile device, wherein in some embodiments, the set of possible callers comprises an existing contact list on the mobile device. The user can then create a subset of callers 201 from the set of possible callers, such that the user can sort each caller located on the contact list into distinct groupings as desired, such as via relationship to the user. The logic then assigns an identifier 202 to the subset of callers, such that the logic can initiate a query to associate a caller with the correct subset of callers. The user then creates a conditional response for each subset of callers. In the illustrated embodiment, the conditional responses include recording an outgoing voicemail message 203 for each of the assigned identifiers, recording a signature 204 for each of the assigned identifiers, and recording a special status message 205 for each of the assigned identifiers. In some embodiments, the user also records a response for each condition, wherein the caller is not associated with any assigned identifier, such that callers not located in the set of possible callers are provided with an appropriate response.

Once a user receives a voicemail or text message 206 from a caller, the logic determines whether the message received is a text message 207. If the message is not a text message, the outgoing voicemail message associated with identifier of the caller is played 208. If the message is a text message, the logic then queries whether a special status period is active 209. Should the user have set the mobile device in a special status state, the text message is automatically responded to with the special status message 210 associated with the identifier of the caller. If the mobile device is not set in a special status state, the signature associated with the identifier of the caller is attached to a text message sent in reply 211. In this way, the user can ensure that the desired conditional response is sent to the caller.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A system for individualizing messages, comprising:
a mobile device in wireless communication with a telecommunications network;
wherein the mobile device includes a user interface and a non-transitory computer readable memory having a logic thereon;
wherein the logic is configured to:
recognize a plurality of subsets of callers from a set of possible callers;
assign an identifier to each subset of the plurality of subsets of callers;
generate a plurality of conditional responses associated with the identifier;
wherein the conditional responses include:
sending a voicemail message stored on an audio file associated with the identifier when a caller from the subset of callers associated with the identifier is directed to leave a voicemail;
adding a signature stored on a text file associated with the identifier when a text message is sent to the caller from the subset of callers associated with the identifier; and
replying to a text message with a pre-written message stored on a text file when a text message is received during a designated special status period, wherein the special status period is determined by a user's unavailability.

2) The system for individualizing messages of claim 1, wherein the voicemail message comprises a pre-recorded audio message.

3) The system for individualizing messages of claim 1, wherein the voicemail message comprises a pre-written text message converted to audio via a text-to-speech algorithm.

4) The system for individualizing messages of claim 1, wherein the set of possible callers comprises a contact list stored on the non-transitory computer readable memory.

5) The system for individualizing messages of claim 1, wherein the logic is configured to require a passcode be entered on the user interface before allowing a user to create a subset of callers.

6) A method for individualizing messages, comprising:
accessing a set of possible callers located on a non-transitory computer readable memory of a mobile device in wireless communication with a telecommunications network;
creating a subset of callers from the set of possible callers;
assigning an identifier to the subset of callers;
recording a voicemail message for each of the subsets of callers to the non-transitory computer readable memory;
assigning each voicemail message to one of the identifiers;
playing the voicemail message associated with the identifier when a caller from the subset of callers is directed to leave a voicemail.

7) The method for individualizing messages of claim 6, further comprising:
recording a signature for each of the subsets of callers to the non-transitory computer readable memory;
adding the signature associated with the identifier to a text message sent to a caller from the subset of callers associated with the identifier.

8) The method of individualizing messages of claim 6, further comprising:
recording a special status message to the non-transitory computer readable memory;
setting the mobile device to a special status period;
replying to a text message with the special status message when the mobile device is set to the special status period.

9) The method of individualizing messages of claim 6, further comprising:
storing a passcode to the non-transitory computer readable memory;
prompting the user to enter the passcode before the set of possible callers can be accessed.

10) The method of individualizing messages of claim 6, wherein the voicemail message comprises an audio message.

11) The method of individualizing messages of claim 6, wherein the voicemail message comprises a text message converted to an audio message by a text-to-speech algorithm.

12) The method of individualizing messages of claim 8, wherein the special status message is recorded for each of the identifiers such that the special status message associated with the identifier is sent in response to the text message.
